(19) United States
(12) Patent Application Publication
(10) Pub. No.: US 2007/0152379 A1
(43) Pub. Date: Jul. 5, 2007

(54) SYSTEMS AND METHODS FOR TRANSFORMING REFORMABLE MATERIALS INTO SOLID OBJECTS

(75) Inventor: Theodore L. Jacobson, Pacifica, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: 2Phase Technologies, Inc., Santa Clara, CA (US)

(21) Appl. No.: 11/609,890

(22) Filed: Dec. 12, 2006

Related U.S. Application Data
(60) Provisional application No. 60/749,783, filed on Dec. 13, 2005.

(51) Int. Cl. B29C 43/00

(52) U.S. Cl. 264/500

(57) ABSTRACT

A method of forming an object in accordance with a master shape includes providing a container having first and second elastomeric membranes, providing a volume of particles in the container, introducing a sufficient amount of liquid into the volume of particles to cause a mixture of the particles and liquid to assume a formable state, pressing the master shape into the first membrane with atmospheric pressure to cause the mixture to conform to the master shape, and extracting a sufficient amount of liquid from the container to cause the mixture to assume a stable, force-resisting state, thereby forming the object. The formed object may, if desired, be used as a master to form a complementary shaped object.

### CROSS REFERENCE TO RELATED APPLICATIONS

This application claims priority from U.S. Provisional Patent Application No. 60/749,783, filed Dec. 13, 2005, titled “Systems And Methods For Transforming Reformable Materials Into Solid Objects” (Theodore L. Jacobson, inventor), the entire disclosure of which is incorporated by reference for all purposes.

This application also discloses and claims enhancements of subject matter disclosed and claimed in U.S. patent application Ser. No. 10/824,333, filed Apr. 13, 2004, titled “The Use of State-Change Materials in Reformable Shapes, Templates or Tooling” (Theodore L. Jacobson, inventor). Application Ser. No. 10/824,333 is a continuation of U.S. patent application Ser. No. 10/150,747, filed May 17, 2002, titled “The Use of State-Change Materials in Reformable Shapes, Templates or Tooling,” now U.S. Pat. No. 6,780,352, issued Aug. 24, 2004, which is a continuation-in-part of U.S. patent application Ser. No. 09/478,956, filed Jan. 7, 2000, titled “The Use of State-Change Materials in Reformable Shapes, Templates or Tooling,” now U.S. Pat. No. 6,398,992, issued Jun. 4, 2002, which claims priority from U.S. Patent Application No. 60/115,472, filed Jan. 11, 1999, titled “Generation of Stable Near-Net Shapes from Confined, Mobile, Lockable Particle Masses (The Use of State-Change Mediums in Reformable Shapes, Templates or Tooling).” The entire disclosures of all these applications (including all attached documents) are incorporated by reference for all purposes.

### BACKGROUND OF THE INVENTION

The present invention relates generally to systems and methods for transforming reformable materials into solid objects.

The prior art for making molds or tooling deals for the most part with fabricating, machining, layered deposition forming, molding or casting of tools for a single dedicated purpose. While the tools may be modified or the materials recycled, often this is accomplished only with multiple steps and at considerable expense. Specific instances of quickly reformable molds have been found that rely on beads, sand or other particulate materials being blown or poured into a container with at least one flexible or elastically extensible surface. An article is pushed against or surrounded by the flexible surface and the contained particulate material, and then a vacuum is pulled on the container to remove air so that ambient air pressure consolidates the beads or particles and holds the flexible surface against them in the shape of the article. Likewise, numerous instances have been found of cushions, pads or seats that rely on introducing or vacuuming air from a bead-filled, flexible or stretchable sealed envelope, while other instances have been found of reformable shapes comprising flexible envelopes that contain mixtures of beads or microspheres combined with binding yet flowable lubricants or highly viscous materials. Some of these shapes have been made temperature responsive, so that heat would soften them and cooling would harden them.

U.S. Pat. No. 6,398,998 to Krenchel, the content of which is incorporated by reference, discloses a method for producing shaped bodies of particulate material by introducing an easily flowable slurry of water and particulate material into a mold with perforated walls and by applying a sufficiently high pressure to the slurry in the mold so as to express a sufficient proportion of the liquid to allow physical contact and inter-engagement between the particles. The method may be carried out continuously in an extrusion process including introducing the slurry under high pressure into an extruder and conveying the slurry through a shaping section of the extruder to a draining and consolidation section of the extruder with drain holes and slits whereby a non-flowable, consolidated, shaped body leaves the extruder through an exit section.

The above-referenced, commonly owned U.S. Pat. Nos. 6,398,992 and 6,780,352 to Jacobson disclose techniques for generating a stable, force-resisting positive or negative representation of a shape. A state-changeable mixture includes uniform, generally ordered, closely-spaced solid bodies and a liquid carrier medium of relatively similar density, with the liquid medium filling any voids or interstices between the bodies and excluding air or gas bubbles from the mixture. Within the mixture, the solid bodies can be caused to transition from a near-liquid or fluent condition of mobility to a stable, force-resisting condition through introduction and then extraction of a slight excess quantity of the carrier medium. To create mobility, this excess quantity or transition liquid is introduced to create a fluent condition by providing a slight clearance between the bodies which permits the gently-forced introduction of at least two simultaneous slip planes between ordered bulk masses of the bodies at any point in the mixture. Transition to the stable condition is caused by extraction of the transition liquid, removing the clearance between bodies and causing them to make stable, consolidated contact.

### SUMMARY OF THE INVENTION

In one aspect of the invention, a method of forming an object in accordance with a master shape includes providing a container having first and second elastomeric membranes; providing a volume of particles in the container; introducing a sufficient amount of liquid into the volume of particles to cause a mixture of the particles and liquid to assume a formable state; pressing the master shape into the first membrane with atmospheric pressure to cause the mixture to conform to the master shape; and extracting a sufficient amount of liquid from the container to cause the mixture to assume a stable, force-resisting state, thereby forming the object. The formed object may, if desired, be used as a master to form a complementary shaped object.

In different embodiments, the volume of particles may be provided in the container in a substantially dry form, in a solid-liquid mixture with sufficient liquid that the mixture is formable, or in a solid-liquid mixture with insufficient liquid for the mixture to be formable. In embodiments where the volume of particles is provided in the container before the sufficient amount of liquid is introduced, the method may further include deaerating the volume of particles before introducing the sufficient amount of liquid.

In an embodiment where the volume of particles is provided in the container in a substantially dry form, the liquid is introduced into the volume of particles after the volume of particles is in the container, the amount of liquid introduced into the volume of particles is sufficient to substantially fill interstices between the individual particles, and further includes an excess amount of liquid.

In an embodiment where the volume of particles is provided in the container in a solid-liquid mixture with sufficient liquid that the mixture is formable, the liquid is introduced into the volume of particles to form the mixture in the formable state before the volume of particles is in the container, and providing the volume of particles in the container is accomplished by introducing the mixture in the formable state into the container.

In an embodiment where the volume of particles is provided in the container in a solid-liquid mixture with insufficient liquid for the mixture to be formable, the volume of particles is provided in the container as a mixture with a first amount of liquid that partially fills interstices between individual particles, but is insufficient for the mixture to be in the formable state, introducing the sufficient amount of liquid into the volume of particles is accomplished by introducing a second amount of liquid into the container after the volume of particles and the first amount of liquid are already in the container, and the first and second amounts of liquid, when combined with the volume of particles, result in the mixture in the formable state.

In another aspect of the invention, a method of forming an object in accordance with a master shape includes providing a container having an elastomeric membrane; providing a volume of particles in the container, the volume of particles having at least some air in interstices between individual particles; deaerating container to remove air from the interstices; introducing a sufficient amount of liquid into the volume of particles to cause a mixture of the particles and liquid to assume a formable state; pressing the master shape into the membrane with atmospheric pressure to cause the mixture to conform to the master shape; and extracting a sufficient amount of liquid from the container to cause the mixture to assume a stable, force-resisting state.

Implementations of the above aspects may include one or more of the following. Extracting the sufficient amount of liquid may be done through one or more screen elements placed proximal to the volume of particles. The method may further include heating and driving liquid from the particle volume, or providing a binding adhesive to lock the particles into a force-resisting mass, or solidifying the liquid within the shaped reformable material, or withdrawing the liquid to leave a residue of liquid on the shaped reformable material and then solidifying the residue.

Pressing the master shape into the first membrane may include applying a flexible vacuum cap sealed over the shape and against the first membrane, evacuating air from a space between the first membrane and the vacuum cap so that the particles and the master shape are pressed together by atmospheric pressure acting in opposed directions against the vacuum cap and the second membrane. Subsequently, air can be introduced into the vacuum cap, and the cap and the master shape removed from the formed surface of the first membrane.

Alternatively, pressing the master shape into the first membrane may include placing the master shape on an air-impermeable surface, placing a membrane of the container over the shape, and placing a vacuum cap or a vacuum-bagging film over the container to effect forming of the elastomeric membrane against the master shape.

The method may be implemented by placing the master shape on the top elastomeric surface of a first rigid-framed container and placing a membrane surface of a second container over the master shape. The second container may fit inside the frame of the first container and a vacuum cap positioned and sealed outside the second container against the surface membrane of the first container. The volume under the vacuum cap can be evacuated and the master shape pressed between the elastomeric sides of the first and second containers. The vacuum cap can be vented with air, the first container removed, the shape removed from the membrane of the second container, and the first container placed adjacent to the second container so as to form a closed, shaped cavity complementary to the surface of the master shape.

In another aspect of the invention, apparatus for forming an object in accordance with a master shape includes a container to hold a volume of particles, with the container including a frame with first and second elastomeric membranes, a first port to deaerate the volume of particles, and a second port for introducing a sufficient amount of liquid into the volume of particles to cause a mixture of the particles and liquid to assume a formable state; and a press coupled to the container to move the master shape into the first membrane to cause the mixture to conform to the master shape, thereby forming the object.

In another aspect of the invention, apparatus for forming an object in accordance with a master shape includes a container to hold a volume of particles, with the container including an elastomeric membrane, a first port to deaerate the volume of particles, and a second port for introducing a sufficient amount of liquid into the volume of particles to cause a mixture of the particles and liquid to assume a formable state; a vacuum activated seal for the container, with the seal including a channel having one or more legs angled outwardly and spaced apart, the legs having contact areas adapted to be pressed against a surface with a greater force per unit area than atmospheric pressure, the channel having an opening therein, and a tube penetrating from the outside of the channel to the inside of the channel through the opening; and a press coupled to the container to move the master shape into the membrane to shape a reformable material into the object according to the master shape.

Implementations of the above aspect may include one or more of the following. The second membrane can be bonded to the frame. The first membrane can be mounted to a seal. A clamp can secure at least one membrane to the frame. One or more ports can be provided on the frame. Liquid, evacuation, and vacuum-activated seal tubes can be mounted to the frame. A rim evacuation screen element can be positioned in the frame. The frame can be rigid or flexible. A vacuum activated seal can be provided on the frame. A tube can be used for evacuating and filling the container. Double layer screens having feed elements to distribute and extract liquid through the volume of particles can be used. One or more screens can be used to conform to the master shape. One or more internal screens can be mounted with the particles flowing on both sides of each internal screen.

Continuing on, the frame can have one or more containers joined together around the master shape or alternatively can have one or more containers joined by vacuum seals. One or more feed tubes can connect to an interior element inside the membrane. A flexible spine element can be used within an interior cavity of the container. One or more reinforcement fibers can be used, and in certain implementations, the fibers can be distributed in bundles within the volume of particles. An air pump or source can be used to provide internal pressurization. A vacuum source can provide a vacuum between a cavity in the container and the container. An air source and a vacuum source can alternately pressurize and vent the container to distribute the volume of particles therein. A seal ring can be used. The seal rings can be mounted against seals or can be mounted with attached seals. The attached seals can be vacuum activated. A second container can be joined with the container and wherein a vacuum is formed in an interior of the joined containers. The master shape can be mounted on the seal ring. Flanges can be mounted to control a mating line between opposed membranes of containers.

A second container can be positioned within a cavity formed by an outside container. A vacuum seal can be used with a vacuum cap. A vacuum tube can be used that penetrates through the membrane. A vacuum cap with mounted container can be used in place of the membrane. One or more screen elements can be placed proximal to the volume of particles to extract the liquid. Atmospheric pressure holds the volume of particles in place against the elastomeric membrane when the master shape is removed from the membrane. A heater can be used to heat and drive liquid from the particle volume. The container can have a rigid outside frame and top and bottom elastomeric membranes facing the top and bottom surfaces of the container, and wherein the master shape is pressed against the top elastomeric membrane of the container by atmospheric pressure. An envelope with a vacuum seal on its perimeter can contain the mass of particles and extract air from between the master shape and the envelope.

The master shape can be placed on the top elastomeric surface of a first rigid-framed container and a membrane surface of a second container placed over the master shape. An expander within the container can be used to press the particulate material against master shapes and against cavity walls of other containers. The apparatus can have a second container cooperating with the first container to form a complementary cavity from the master shape; and a third container placed in the complementary cavity to replicate the master shape. A second elastomeric membrane can be used that either overlaps or abuts the adjacent membrane. Additional containers each having a membrane coupled to the container can be used to form a continuous surface of membranes. Additionally, one or more additional containers can form a shape complementary to the interior of a master cavity.

In another aspect of the invention, a base station for forming an object in accordance with a master shape includes a liquid receiver; a vacuum source to evacuate air from the liquid receiver; an air compressor to generate pressurized air; and a controller coupled to the liquid receiver, the vacuum source, and the air compressor to form the object.

In another aspect of the invention, a method for shaping a reformable material includes holding a volume of particles inside a container having a first elastomeric membrane surface; infusing the volume of particles with a liquid; agitating the liquid to provide one or more surges of liquid to mobilize the volume of particles; and pressing a master shape into the membrane with atmospheric pressure.

A further understanding of the nature and advantages of the present invention may be realized by reference to the remaining portions of the specification and the drawings.

### BRIEF DESCRIPTION OF THE DRAWINGS

FIG. 1A (with a detailed magnified segment FIG. 1A-1) and FIG. 1B (with a detailed magnified segment FIG. 1B-1) show a first container embodiment having a master shape and a vacuum cap to create a shaped impression complementary to the master shape;

FIGS. 1C-1E show an exemplary operation of the container with the master shape to form an impressed shape complementary to the master shape;

FIG. 2A shows a second exemplary embodiment of a container which has a flexible rim frame and elastomeric membrane faces;

FIGS. 2B and 2C show two forms of a screen element in the container of FIG. 2A;

FIG. 2D is a cutaway view of the container of FIG. 2A showing a vacuum cap sealed against a surface with the volume of air between the cap and the surface evacuated;

FIG. 2E shows the vacuum cap removed and the container being held in its shape by maintenance of liquid-extracting vacuum on the container of FIG. 2A;

FIG. 2F shows a cutaway view of a third exemplary embodiment of a container having a vacuum seal bonded to its perimeter;

FIG. 2G shows a four-part screen which has been formed around a master shape within the container of FIG. 2F;

FIG. 3A shows a fourth embodiment of a container draped over a master shape placed against the upper surface of the container;

FIG. 3B is a cutaway view showing container of FIG. 3A with its integral seal affixed to a membrane frame of the container;

FIG. 3C shows two of the containers with vacuum seals affixed together around a master shape to create a cavity with surfaces that are complementary to the shape;

FIGS. 4A (with a detailed magnified segment FIG. 4A-1) and FIG. 4B show two exemplary containers with a seal ring;

FIGS. 5A-5C show an exemplary container that can be formed inside a cavity;

FIG. 6A shows a transition of a container held within a rigid ring which allows transit of the container's tubes from outside the ring into the container;

FIGS. 6B and 6C show a variation of the container of FIG. 6A with reinforcing elements therein;

FIGS. 7A and 7B show a schematic of an exemplary base station to form and immobilize a particle mass, and to then soften and reform the mass within container embodiments of FIGS. 1A and 2A;

FIG. 7C is a block diagram illustrating a process controller for the base station and toolbed of FIGS. 7A and 7B;

FIG. 7D shows the containers of FIGS. 4A and 4B closed around a container formed within a cavity as described with reference to FIG. 6A;

FIGS. 8A-8E show an exemplary agitation process using periodic variations in pressure;

FIG. 8F shows another exemplary agitation process with low frequency vibrators to create broadly or globally distributed liquid surges;

FIGS. 9A and 9B show another exemplary agitation method that helps to carry a state-change mixture from a tank to a containing container volume; and

FIG. 9C shows a method of close-packing the particles in a container.

### DESCRIPTION OF SPECIFIC EMBODIMENTS

Overview

The drawings show structure diagrams for the system and process flow diagrams for various processes in shaping a reformable material into solid objects. In most embodiments, the reformable material takes the form of a reversible state-changeable mixture having a plurality of solid bodies and a carrier medium, with the carrier medium filling any voids or interstices between the bodies. In most embodiments, the carrier medium is a liquid preferably excluding any air or other gases from the mixture, and most of the discussion will revolve around such embodiments. However, some embodiments use a carrier medium that is a liquid-gas froth.

Within the mixture, the solid bodies can be caused to transition from a formable state, preferably a near-liquid or fluent condition of mobility, to a stable, force-resisting condition through introduction and then extraction of a slight excess quantity of the carrier medium beyond that required to fill the interstices of the bodies when closely packed. An apt analogy is that the mixture in its formable state may be loosely compared to quicksand, while the mixture in its stable state may resemble hard-packed sand or even cement, with the transition being caused by the transfer of a relatively small amount of liquid.

As described in additional detail in the above-referenced U.S. Pat. No. 6,780,352, embodiments may be characterized by one or more of the following advantages: the ability to pressurize a mixture and drive it against a complex surface as if it were a liquid; the ability to create a “near-net” or extremely accurate representation of a shape due to the negligible volumetric change that accompanies a state change; the ability to effect the state-change with a very small volume of single-constituent transfer and with consequently small actuation devices without the need for a vacuum pump, without chemical reactions, and with no need for thermal or electrical energy to be applied to the mixture; the ability to greatly alter the volume of any elastic or otherwise dimensionally changeable container, envelope or chamber through the free-flowing transfer of the mixture from one container to another; and the ability to tailor the mixture to satisfy a wide variety of physical specifications in either the flowable or the stable state.

Particle and Liquid Introduction into Container

Particles can be introduced into the container by several methods and in a variety of conditions. If the particles are in a clean condition and with an acceptable particle size distribution, then they can be poured in dry form into a container with the top membrane removed. An airflow out of the toolbed might be induced through internal screen elements so that low-density fine particles are held within the toolbed rather than being free to circulate in the air above and around the container. The particles could be infused with liquid while within the toolbed and so be made mobile for varied forming or forming and stabilizing (consolidating) processes as will be described in detail.

Dry particles may also be introduced into a holding tank in which they would be combined with liquid to create a slurry form. The slurry would then be transferred from the holding tank into a container as required. Since the slurry is already in a mobile state, mere extraction of liquid would cause to assume a stable, force-resisting state.

Particles may also be conditioned with a wetting or lubricating agent so that they cling together like a wetted small-grain sand or even resemble a mud if the particle size is sufficiently small. In this form they can be scooped into an open container or into an open-top tank without concern for airborne particulate matter contaminating a workspace. Additionally, in the wetted sand or mud-like form the particles can be additively placed over a pattern shape to develop a layer of desired uniform thickness or varied thickness. Further, the upper surface can be displacement-sculpted by individual tools or can be given a shape on the exposed surface by pressing a pattern shape against the somewhat cohesive particle mass. With a membrane held against the surface either by “damp clinging” or slight pressure differential, the sculpting and shaping operations could be performed without direct contact with the particles and wetting agent.

A particle mass in either the dry or wetted condition can be formed to a degree without the introduction of liquid which completely fills the interstices between closely spaced particles, depending on the lubricity of the particles. There might for instance be a pre-forming step or steps as just described, following which just sufficient liquid is introduced into the particle mass as to cause mobility under light pressure to further assist conforming of the particle mass to a pattern shape. With extraction of this excess liquid the particles would then assume a more stable form. If the mass were contained within an airtight elastomeric envelope, within a container with one elastomeric surface or within a container with a frame and with two elastomeric membrane faces, then extraction of the liquid below atmospheric pressure would cause the membrane or membranes to press against the particle mass, further stabilizing it.

With particles that have a degree of surface friction when in a mass, particle mobility when infused with liquid might be aided by first deaerating the particle mass so that there is no air contained along with the liquid filling the interstices of the particle mass. With the liquid acting around each individual particle, the highest degree of mobility would be achieved for all the particles in the mass.

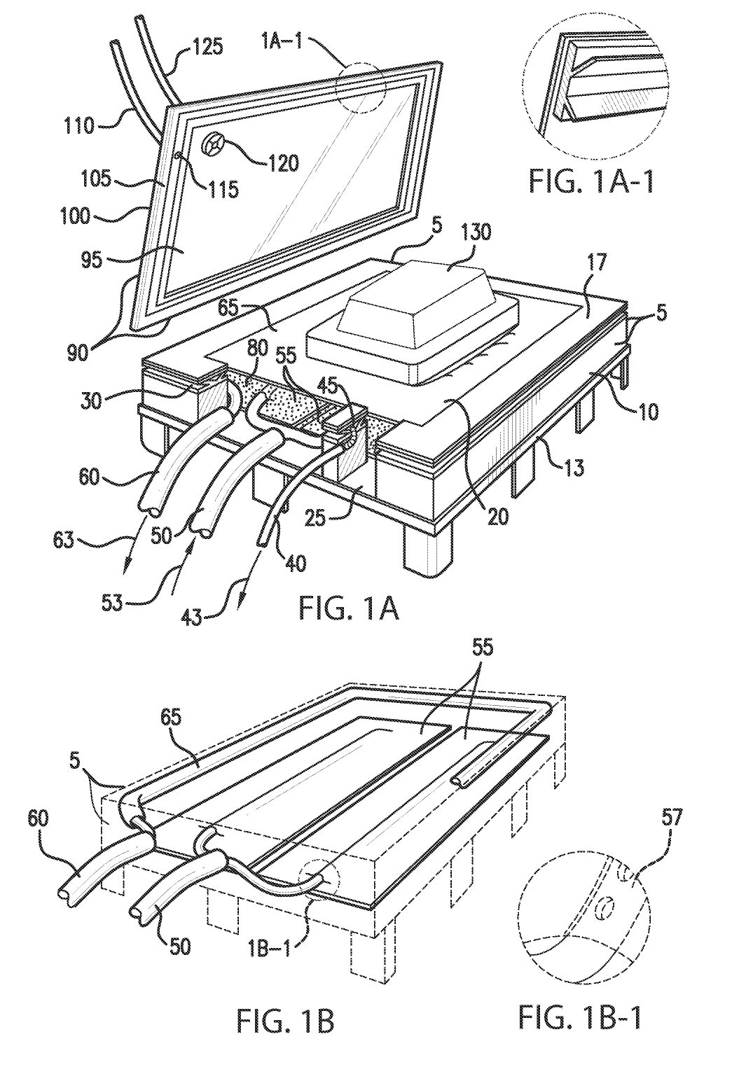

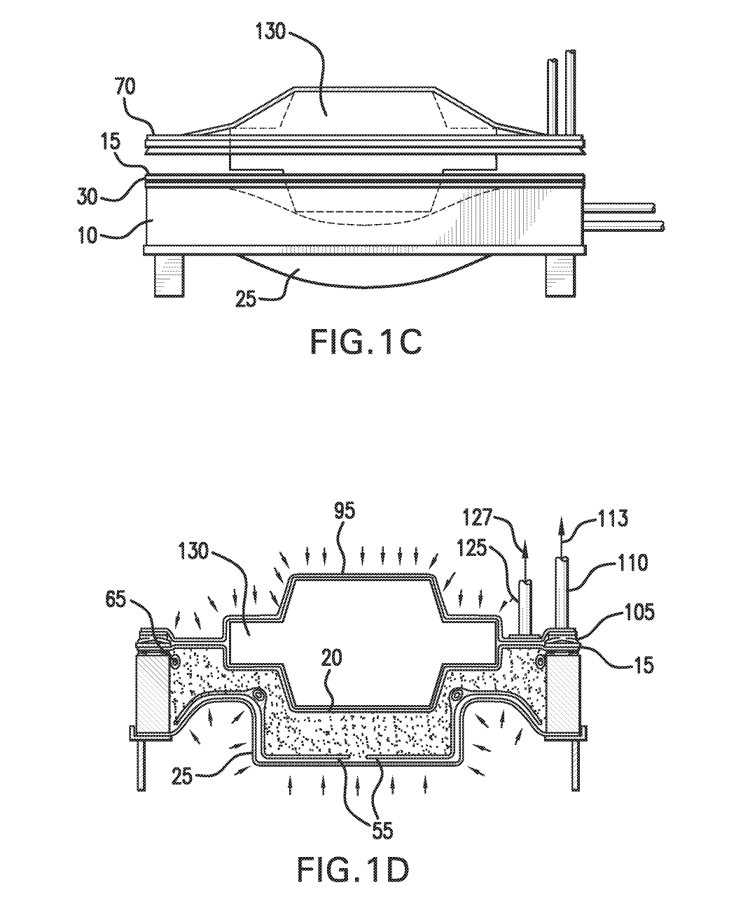

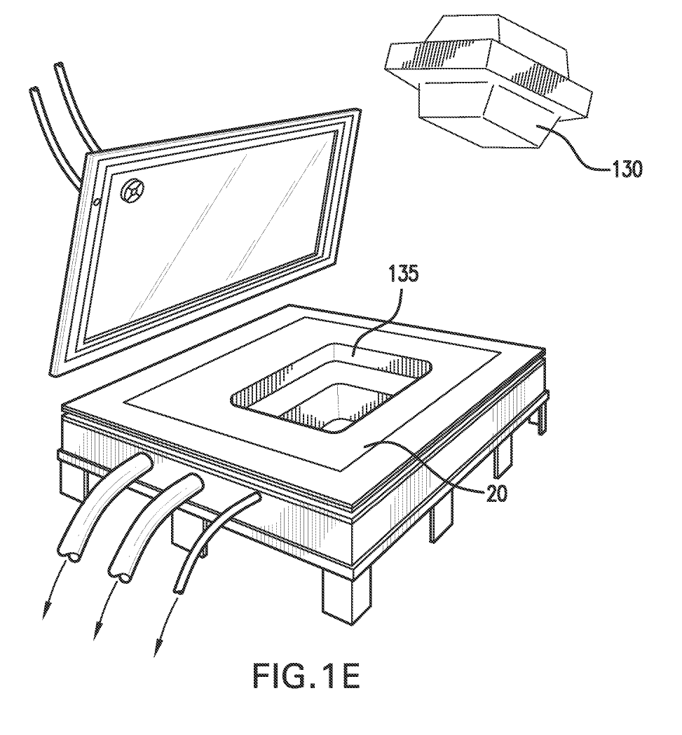

Form and Operation of Particle-Filled Containers (FIGS. 1A-6C)

FIGS. 1A-1D show a first container embodiment, a master shape and a vacuum cap, and further show a sequence of operations to create a shaped impression, complementary to the master shape, in the surface of one elastomeric membrane face of the container. Turning now to FIG. 1A, a container 5 is shown with a rigid container frame 10 and elastomeric top and bottom membranes 20 and 25, resting on a base 13 which elevates bottom membrane 25 above any surface that base 13 and container 5 rest on. Top membrane 20 is bonded to a perimeter frame 17 so as to have an air-tight interface between container frame 10 and membrane 20 via a continuous vacuum-activated seal 30 which is bonded to container frame 10. Seal 30 is resilient and acts much like a suction cup to hold perimeter frame 17 to container frame 10. Bottom membrane 25 is bonded directly to rigid container frame 10 since the membrane is not a working surface subject to damage, in contrast to the working surface of membrane 20 which is subject to damage.

In one embodiment, bottom membrane 25 can be affixed by a perimeter frame and vacuum seal as described in reference to frame 17 above. In yet another embodiment with more complexity, mechanical clamps and a pressure seal can be employed to affix either top or bottom membranes.

Tubes 40, 50 and 60 are shown penetrating container frame 10. Tube 40 communicates with seal 30 through an opening 45, and seal 30 affixes membrane 20 to container 5 by a vacuum (indicated by arrow 43) acting through tube 40. Vacuum seal 30 can be inactivated by introducing air through tube 40, allowing membrane 20 affixed to frame 10 to be removed in order to insert or remove a volume of particles from container 5, or to replace a damaged membrane 20 or internal screen element as will be described below.

Tube 50 communicates with a main particle screen 55 (FIG. 1B) which is overlaid with a volume of particles 80. Arrow 53 indicates the flow of liquid into the particle volume through screens 55. The two particle screens 55 serve to hold all particles in container 5 while allowing liquid to flow in and out of the particle mass. There is a sealed double-layer construction of the screens with tube 50 communicating between the layers. The particles cannot penetrate the outer layers of the screens and so do not move into the tubes as air is evacuated or liquid extracted. Detail 57 of FIG. 1B-1 shows an extension of tube 50 penetrating inside the double-layered screen. The extensions have perforations that enable distributed liquid flow along the length of the tube inside the screen. Tube 60 communicates with a rim evacuation screen element 65 which follows the entire inside upper perimeter of frame 10 and is likewise perforated along its length within element 65. Arrow 63 points outward to indicate deaerating vacuum force acting on the container volume via the evacuation element.

Turning now to the top of FIG. 1A, a vacuum cap 90 is shown with a continuous flexible or elastomeric membrane 95 bonded to another perimeter frame 100, the frame also having a continuous vacuum-activated seal 105 bonded to frame 100. Seal 105 is generally identical in function to seal 30 design and can be identical in design as well. Vacuum cap 90 has a tube 110, which communicates to the inner surface of the vacuum seal through an opening 115, and a tube 125 which in turn communicates with the underside of membrane 95 through an airtight port 120.

A master shape 130 is shown resting on membrane 20. The master shape will be used to form a shaped impression in the membrane as described next. To prepare for the forming process shown in FIGS. 1C-1E, a membrane 20 is sealed to the container; air is removed from the volume of particles as shown by arrow 63; and liquid is introduced into the particle volume as shown by arrow 53. Liquid flow is cut off when there is sufficient liquid to allow particles to move in relation to adjacent particles as displacing force is exerted on either the top or bottom membrane of the container.

FIG. 1C shows a side view of container frame 10 with a vacuum cap 70 resting over master shape 130 prior to being sealed against the membrane perimeter frame 15 to which the membrane 20 is bonded, with the membrane affixed using seal 30 to container frame 10. Master shape 130 is resting on the unformed surface of membrane 20 with the movable particles between membranes 20 and 25.

FIG. 1D shows a cutaway view with vacuum cap 90 affixed by seal 105 against perimeter frame 15 by vacuum through tube 110 as shown by an arrow 113. In addition the space between vacuum cap membrane 95 and top membrane 20 has been evacuated through tube 125 as shown by an arrow 127. This causes the vacuum cap to act as a press, driving shape 130 against the top membrane. The vacuum cap membrane 95 is pressed down against master shape 130 and against the surface membrane 20 by atmospheric pressure which also acts opposedly against container bottom membrane 25. Liquid is then extracted by a pump or vacuum from the particle volume through a tube (not shown) through particle screen 55, causing atmospheric forces acting on bottom membrane 25 to pack the particles against top membrane 20 which is forced against the master shape since air has been evacuated from between the vacuum cap membrane and top membrane 20. Any leakage of air into the container, which would add atmospheric pressure back to the container and so reduce the packing force on the particles, can be removed by continuing vacuum extraction of liquid through particle screens 55 or by vacuum extraction through perimeter evacuation screen element 65.

FIG. 1E shows the container with master shape 130 removed from the surface of the membrane 20, revealing an impressed shape 135 which is complementary to master shape 130. The differential pressure on the container by vacuum extraction is continued, thereby maintaining opposed atmospheric forces that act to keep membranes 20 and 25 pressed against the particles and so immobilizing them to keep the impressed shape stabilized.

Referring now to FIG. 1A-1, the vacuum activated seal is further described. In form the seal is a continuous channel with the legs angled outward. The channel has a single opening and a vacuum and vent tube connected to it as described with reference to FIG. 1A. The material of the seal is resilient since the legs will be pressed against a surface and must conform to and seal against the surface. The legs are separated by a sufficient distance that they will be pressed into contact with the surface by atmospheric pressure with a greater force per unit area than atmospheric pressure. In function, when the legs of the channel are pressed against a smooth surface and the vacuum introduced inside the channel, the seal legs deform against the surface and the deformed area is substantially less than the area inside the channel.

In experiments a ratio of deformed area to inside area of 1 to 2 has been shown to be very effective in sealing against a smooth surface if the durometer of the seal's elastomeric material is around 40. In operation the seal is simply placed against or gently pressed against a smooth air-impermeable surface. A vacuum is introduced through the tube, extracting air from within the seal and so enabling atmospheric pressure to force the seal against the surface. Any leakage from atmosphere outside the seal is scavenged by the vacuum and so does not enter the volume inside the perimeter of the seal even if a full vacuum is imposed on that volume. To release the seal air is introduced via the tube or a small blade can be slipped between the seal and surface to break the internal vacuum.

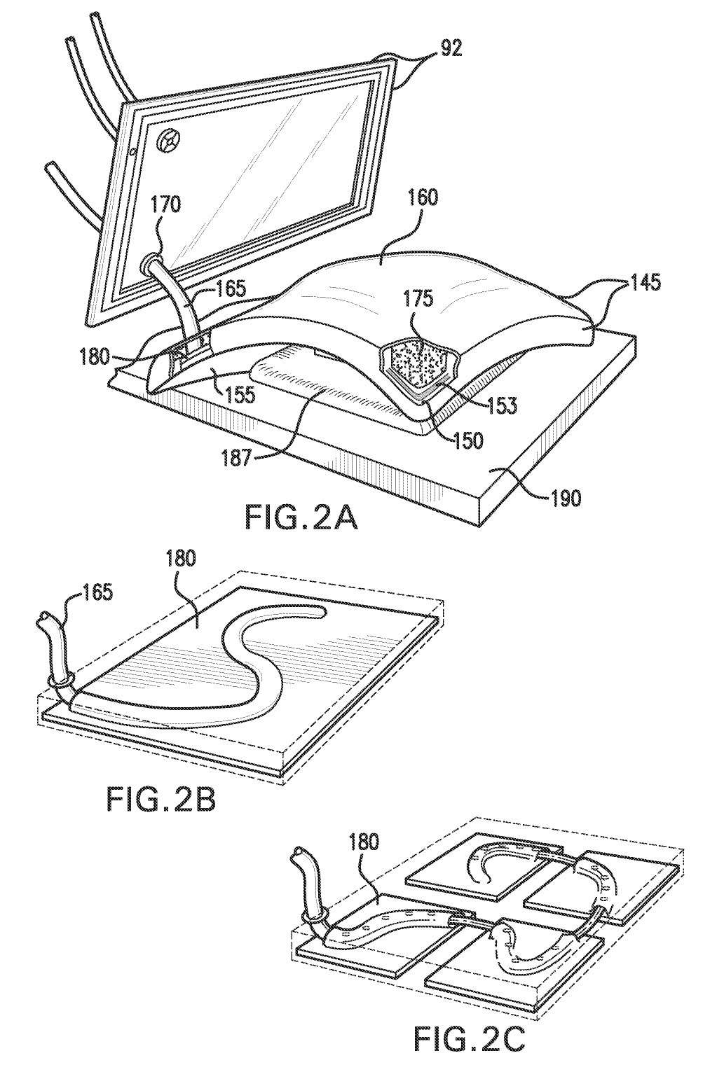

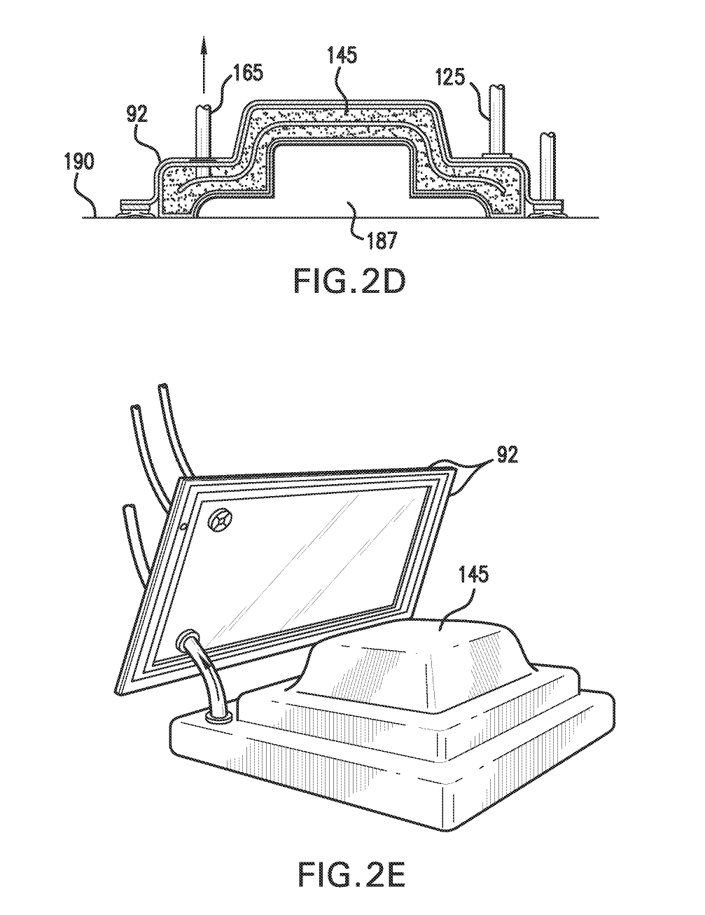

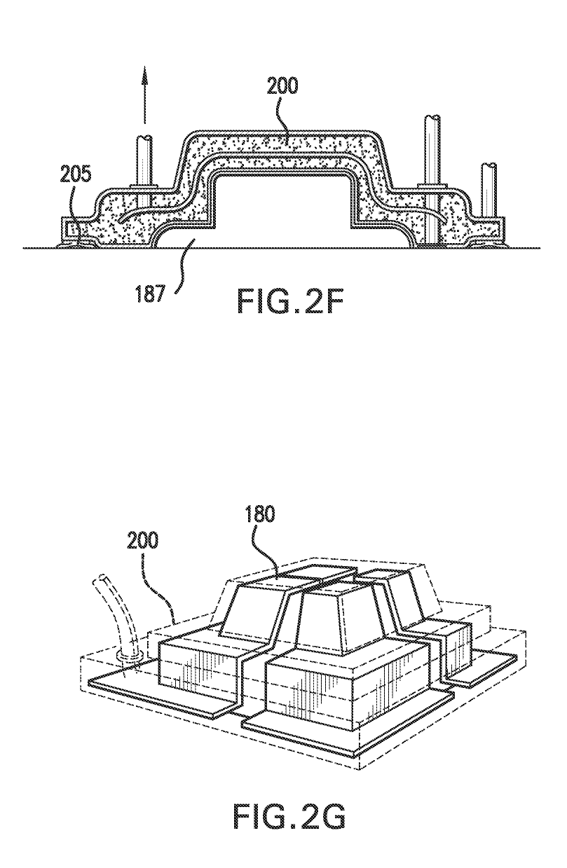

FIG. 2A shows another embodiment of a particle filled container 145 in the form of an envelope which has a flexible rim frame 150 and elastomeric membrane faces 155 and 160. Frame 150 can include a flexible member 153 that allows flexure vertically but not horizontally. This element may be composed of thin spring steel, a fiber composite or any other material that is flexible in the vertical direction but stiff enough in the horizontal direction to prevent horizontal deformation of frame 150 when the membrane faces are stretched over a master shape. A single evacuation liquid tube 165 communicates through a vacuum cap tube port 170 with a particle-filled volume 175 and through a screen element 180. In this view the container has been evacuated of air and filled with liquid as previously described and placed over a master shape 187 which rests on a rigid air-impermeable surface 190. Also shown is a vacuum cap 92 which is identical to the vacuum cap of FIGS. 1A-1E with the exception of port 170.

FIGS. 2B and 2C show two forms of the screen element 180. In FIG. 2B the element 180 is continuous and is coupled to tube 165. While the continuous element of FIG. 2B is appropriate when the screen material and the facing membranes are elastic; an embodiment with a plurality of separate elements 180 is appropriate where the screen material is not elastic as are the facing membranes so that the elements conform well to complex shapes such as master shape 187 (FIG. 2D). The screen with quad elements 180 in FIG. 2C allows for greater conformity as shown in more detail in FIG. 2G.

FIG. 2D is a cutaway view that shows vacuum cap 92 sealed against surface 190 with the volume of air between the cap and the surface evacuated. Atmospheric pressure acts through the cap to press container 145 against shape 187. Liquid is then vacuum-extracted via tube 165, causing atmospheric pressure to compress the volume of particles between the container faces or surfaces. The interior face of the container now has a shape complementary to that of the master shape.

FIG. 2E shows the vacuum cap removed and the container being held in its shape by maintenance of liquid-extracting vacuum on the container. As shown with the container of FIGS. 1A-1E, the particles within container 145 are immobilized and the container holds its shape.

FIG. 2F shows a cutaway view of a container 200, which is identical to container 145 except for a vacuum seal 205 bonded to its perimeter. In this embodiment, the vacuum cap and container are merged into a single device. The vacuum seal 205 affixes the container 200 to an air-impermeable surface over the master shape, with air evacuated from beneath the container. The container's inside surface has been pressed against the shape, following which vacuum extraction of the liquid causes the outer surface to be pressed by atmospheric pressure against the particles which are in turn pressed against the inside surface. When the vacuum seal is released, atmospheric pressure is introduced against the inside surface also, and the particles are held immobilized as previously described. The container is then lifted from the master shape and has its stability maintained by atmospheric pressure acting against the vacuum within the particle volume as previously described.

FIG. 2G shows the four-part screen 180 of FIG. 2C within the container 200 formed around a master shape. The screen is draped and conformed along with the container 200 since each of the screen elements is free to assume its regional contours without exerting stresses on adjacent screen elements.

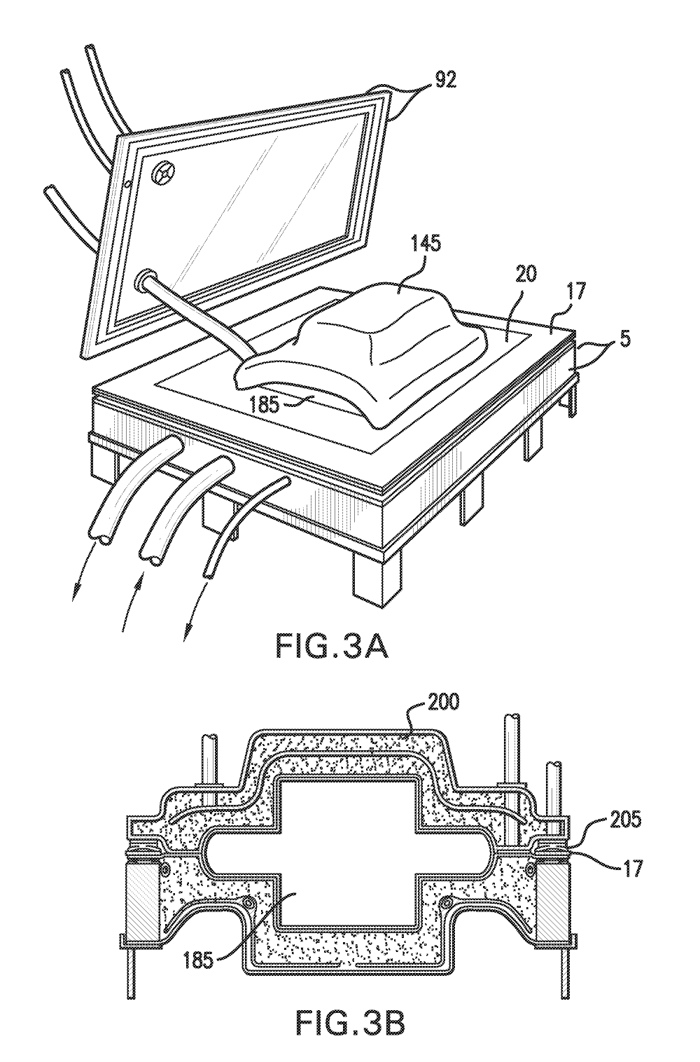

FIG. 3A shows container 145 draped over master shape 185, which in turn has been pushed against the upper surface 20 of container 5 as previously shown. Vacuum cap 92 is placed over the container and sealed to perimeter frame 15; air is evacuated from beneath the cap and liquid extracted from both containers. When the vacuum cap is removed, as previously described the surfaces of both containers in contact with the master shape will maintain contours complementary to the shape.

FIG. 3B is a cutaway view showing the container 200 with its integral seal 205 affixed to membrane frame 17 of container 5. As discussed above, the process of evacuating air and extracting liquid from the containers causes the containers to become fixed to the contours of the master shape.

FIG. 3C shows two of the containers 200 with vacuum seals affixed together around a master shape and processed as previously described to create a cavity with surfaces that are complementary to the shape.

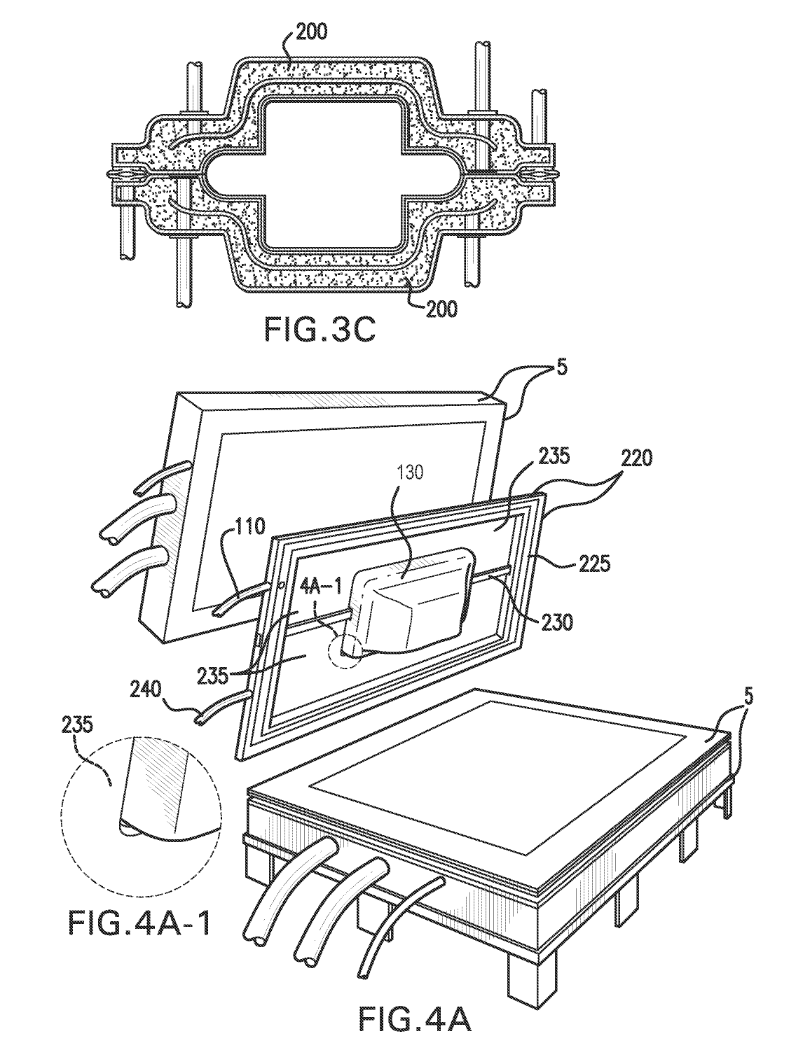

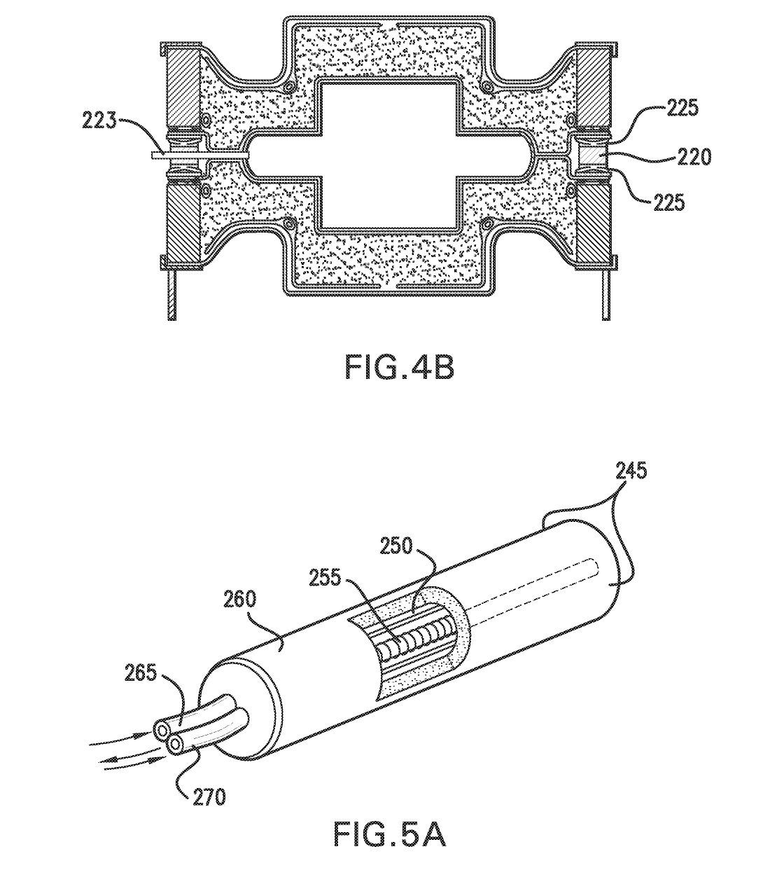

FIGS. 4A and 4B show two containers 5 and a third element, a seal ring 220. The seal ring has vacuum-activated seals 225 (identical to previous seals) on opposed faces, with vacuum provided to the inner side of the seal by vacuum tube 110. The seal ring is capable of holding master shape 130 in a precise location and orientation via a holding element 230. In addition there can be flanges 235 which assure that the mating line between elastomeric faces of the two containers is held to a defined position. The seal ring has a tube 240 which acts in the same manner as tube 125, on the vacuum caps previously described, to evacuate air from around the master part after the containers are impermeably sealed together by the seal ring. As with the previous embodiments and processes, liquid is extracted and extraction force maintained to keep the impressions in the containers stable when the vacuum seals are broken and atmosphere acts on all surfaces of the containers.

FIG. 4B shows a modification of the seal ring 220 which allows access to a cavity formed by a master shape (in this case shape 185). After the containers are shaped around the master the seal ring with mounted master is removed. Holding element 230 is removed from the seal ring and replaced with an access port 223. When the seal ring is placed back between the two formed containers, port 223 furnishes an opening into the cavity, from outside the seal ring, through which a flowable material such as a plastic resin can be introduced into the cavity.

The containers 200 (FIG. 3B,C), which have integral seals around their perimeters, could be utilized in place of the containers shown in 4A and 4B. In this case seal ring 220 would be furnished without its seals and the containers would be adhered directly to the opposed surfaces of the ring.

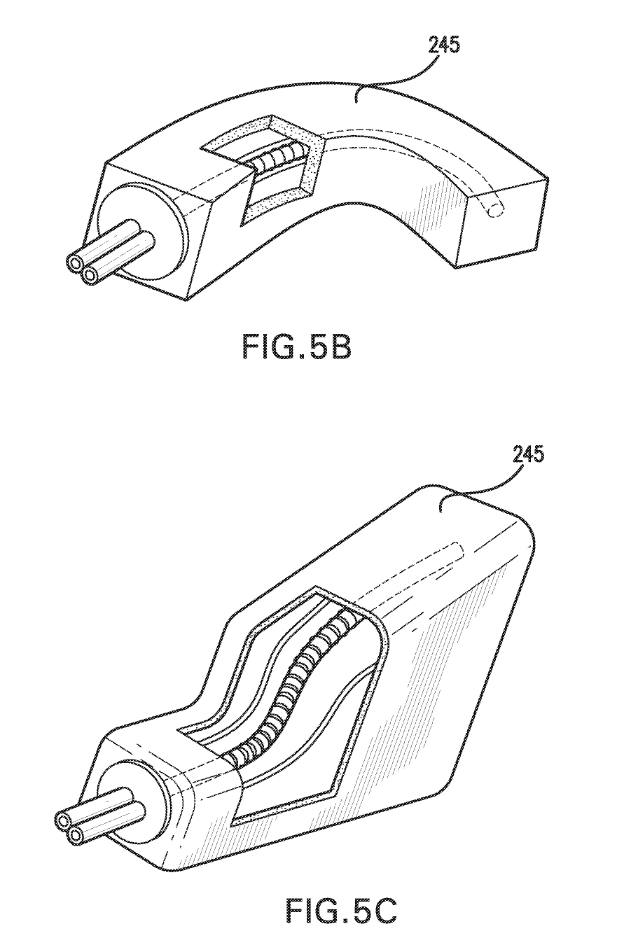

FIGS. 5A-5C show a type of container that can be formed inside a mold cavity, whether the cavity has been created in the reformable containers previously described or has been made by conventional machining, casting or fabricating methods. FIG. 5A shows a container 245 having a closed elastomeric interior membrane 250, a flexible spine element 255, and a closed elastomeric outer membrane 260. A tube 265 communicates with the hollow central volume created by membrane 250 and within which spine element 255 resides. Particulate material is held in the volume between the inner and outer membranes, and a tube 270 communicates with that volume. As described above for containers 145 and 200, air is first extracted from the volume containing the particles and then liquid is introduced to cause the particle volume to be formable. FIG. 5C shows the container in its relaxed state. Following placement of container 245 into a mold cavity, air is introduced into the central cavity created by membrane 250 through tube 265. Air can also be vacuum-extracted from between outer membrane 260 and the mold cavity walls. The volume of particles and outer membrane 260 is driven against the mold cavity walls, following which liquid is extracted from the particle volume through tube 270, causing the particles to be compressed together as previously described.

FIG. 5B shows the container after it has been shaped inside a cavity that transforms from a square to a smaller rectangular cross-section while turning a right angle. FIG. 5C shows a transition from a square to a larger rectangular cross-section. Since the volume of particles is constant the cross-section of the particle volume has thinned. As discussed in more detail below, reinforcement elements can be used within the particle volume to aid in strengthening such forms where the particle volume has been thinned due to the transition to cross-sectional shapes larger than the relaxed state of the container.

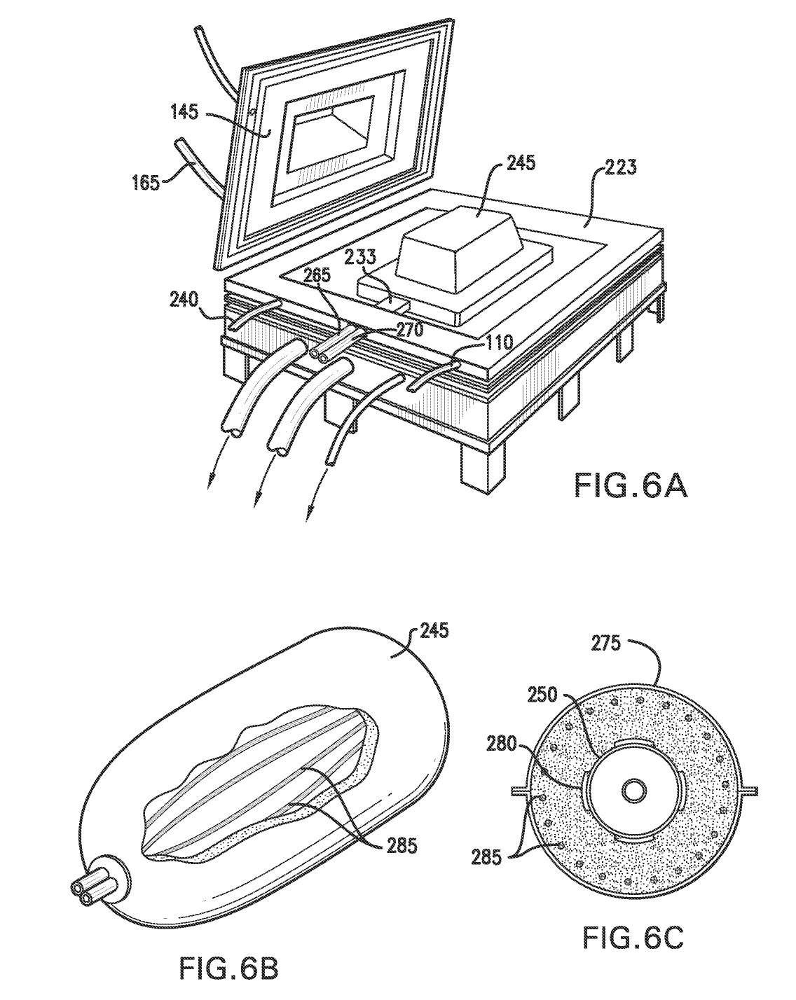

FIG. 6A shows a more extreme transition of container 245 that is held within a rigid seal ring 223 via a holding element 233 which allows transit of the container's tubes from outside the ring into the container. Ring 223 has a vacuum activated seal on the bottom surface which adheres to the membrane frame of a container as previously described in FIGS. 1A-1E; however the top surface of the ring has no seal. A variation of the vacuum cap previously described is shown which will be affixed to the ring's surface by an active vacuum seal. In this embodiment, the vacuum cap replaces the cap membrane with a particle-filled container 145 which is supplied with vacuum and liquid through tube 165 as previously described. Tube 240 communicates with the interior of the ring as previously described with reference to seal ring 220. The result of utilizing an elastomeric container in place of a single-membrane vacuum cap is to provide a shaped lid to the bottom container, so creating a two-part shape which is complementary to the master shape

FIGS. 6B and 6C show a variation of container 245 which has reinforcing elements 285 within. Reinforcing elements 285 are strands of fine glass or other fibers which are flexible and so can change contours as the container is shaped. FIG. 6C shows further detail including a thin shell mold 275 within which the container is shaped. Also shown are bundles of fibers 285 suspended within the particle volume. In other preferred embodiments the fibers can be mounted on the particle screen elements 280 and on the surface of interior membrane 250. Such reinforcing fiber bundles could also be incorporated into all forms of containers in the manners described with reference to these figures.

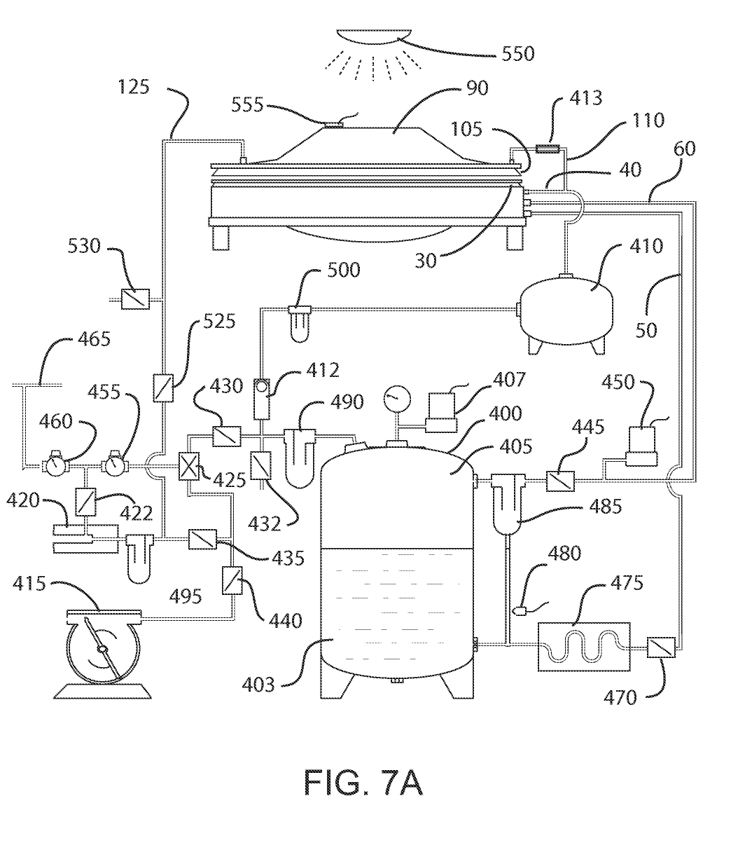

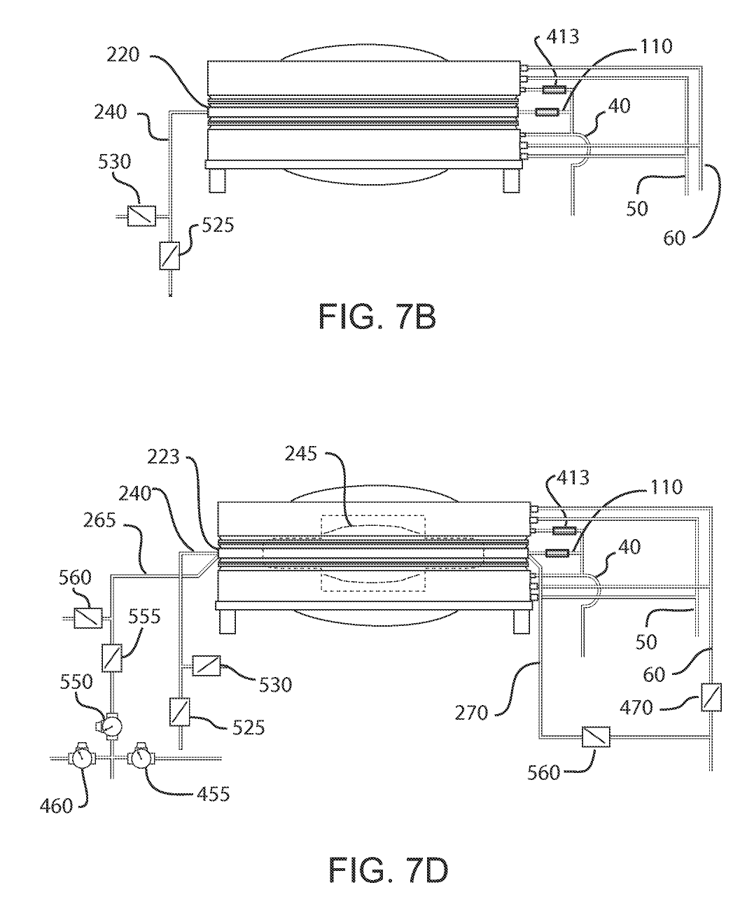

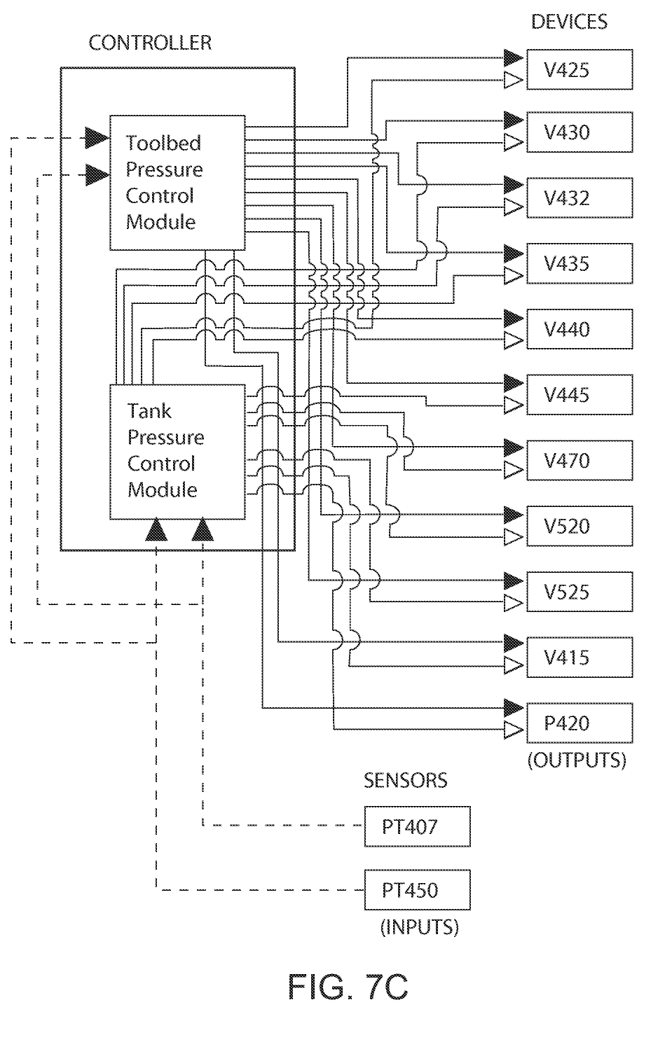

Operation of Base Station (FIGS. 7A-7D)

The containers are processed by a base station which controls air evacuation, liquid filling and liquid extraction. FIG. 7A is a schematic of the base station which shows all of the components necessary to form and immobilize a particle mass, and then to soften and reform the mass within containers of the types described in FIGS. 1A-1E and 2A-2G. The same components are employed along with additional components to process the container types shown in FIGS. 3A-6C as will be described with reference to FIGS. 7B and 7C. In one embodiment, operations are carried out via a menu-driven process controller which combines operations of the components to allow the operator to run the system with a very simple activation sequence. The controller receives sensor input from any process monitoring sensor including vacuum, pressure, liquid level and temperature sensors.

Referring to FIG. 7A, the operation of container 5 is as follows. A tank 400 serves as a liquid, vacuum and air pressure source. An open volume 405 is alternately evacuated and pressurized, and a liquid volume 403 is available to infuse the particle mass in container 5.

The operation of container 5 starts with an evacuation of air from volume 405 using one or both of a pair of vacuum pumps 415 and 420. All valves with the exception of one 3-way valve are 2-way valves, and all are normally closed. The pumps 415 and 420 draw air within the volume through a primary tank valve 430 through a 3-way valve 425 and either or both pump inlet valves 435 and 440. In the configuration shown, pump 420 is a high-capacity venturi type of pump which is driven by an external source of air pressure 465 which passes first through a base station regulator 460. A valve 422 is cycled as required to power pump 42 and is cycled with the operation of pump inlet valve 435. Pump 415 is shown as a “topping” or high vacuum source. Other variations are possible for the base station vacuum source such as a single pump within the system or an external source.

When volume 405 is evacuated by opening the series of valves to one or both vacuum pumps 415 and 420, a reservoir tank 410 is also evacuated. Tank 410 serves as a vacuum reservoir for membrane seal 30 which communicates with tank 410 through tube 40. With volume 405 evacuated and seal 30 activated, a container evacuation valve 445 is opened which communicates between volume 405 and the interior of container 5 through tube 60 to interior rim evacuation screen 65 as described in the previous FIGS. When air within the particle mass held in container 5 is evacuated to a predetermined vacuum level and is read by a sensor (pressure transmitter) 407, valve 445 is closed, isolating a sensor (pressure transmitter) 450 on the container side of the valve. Tank 400 is now pressurized to prepare for a liquid infusion of the evacuated particle mass. During pressurization of tank 400 (described below), tank 410 is isolated by a check valve 412 which prevents air leakage into the tank 410 and so maintains a vacuum source for membrane seal 30 of toolbed 5.

Before pressurization, the vacuum on tank 400 is relieved by a venting valve 432 which introduces atmosphere. 3-way valve 425 is now opened to introduce pressurized air into the tank to a level determined by a regulator 455, and then a liquid flow valve 470 is opened. Liquid passes from liquid volume 403 through the flow valve via tube 50 to the interior of container 5 via main particle screen 55 (previously described). The liquid flows into the interstices between the particles and is supplied in sufficient excess to allow the particles to be mobile with respect to one another. The predetermined liquid excess is indirectly sensed by sensor 450 which reads the level of vacuum or pressure within the container, and valve 445 is closed when the sensor reading is at a predetermined value.

Container 5 is now ready for impressing a master shape into the top membrane as previously described. The volume 405 of tank 400 is now returned to an evacuated state by switching 3-way valve 425 to cut off air pressure from regulator 455, opening vent valve 432 in order to bleed air pressure to atmosphere, and then opening valves to one or both vacuum pumps. During evacuation any air that has leaked into the tank 410 is also evacuated.

Vacuum cap 90 (previously described) is now placed over the shape resting on the container's top membrane. A tubing clamp 413 on a tube 110 is opened to activate cap seal 105 by the vacuum in the tank 410. Valve 435 to vacuum pump 420 is now closed to isolate it from pump 415 and from tank 400. A vacuum cap valve 525 is now opened as is a pressurized air valve 422 to activate the vacuum venturi pump 420. Air is now evacuated from between the membrane of vacuum cap 90 and the container top membrane as previously described. Valve 525 may be closed and a valve 530 opened to bleed air back under the vacuum cap, and alternating the opening and closing of these valves will cause the vacuum cap and container surface membranes to repetitively “pulse” and so distribute the particulate matter under the surface membrane around the master shape. These cycles of conforming the surface membrane and particles to the shape are ended with a constant predetermined vacuum being held between the two membranes by pump 420.

While vacuum continues to be held between the membranes, liquid flow valve 470 is opened. Since tank 400 is under vacuum the excess liquid in container 5 is driven (by atmospheric pressure acting on the membranes of container 5) back into the tank. Atmospheric pressure holds the particles in a compressed state while vacuum cap valve 525 is closed and vacuum cap vent valve 530 is opened. Tubing clamp 413 is also closed on tube 110 to isolate vacuum cap seal 105. The vacuum cap and master shape are then removed to reveal the complementary shape impressed in the container surface membrane as earlier described. Vacuum is maintained on the container since liquid flow valve 470 has remained open to tank 400.

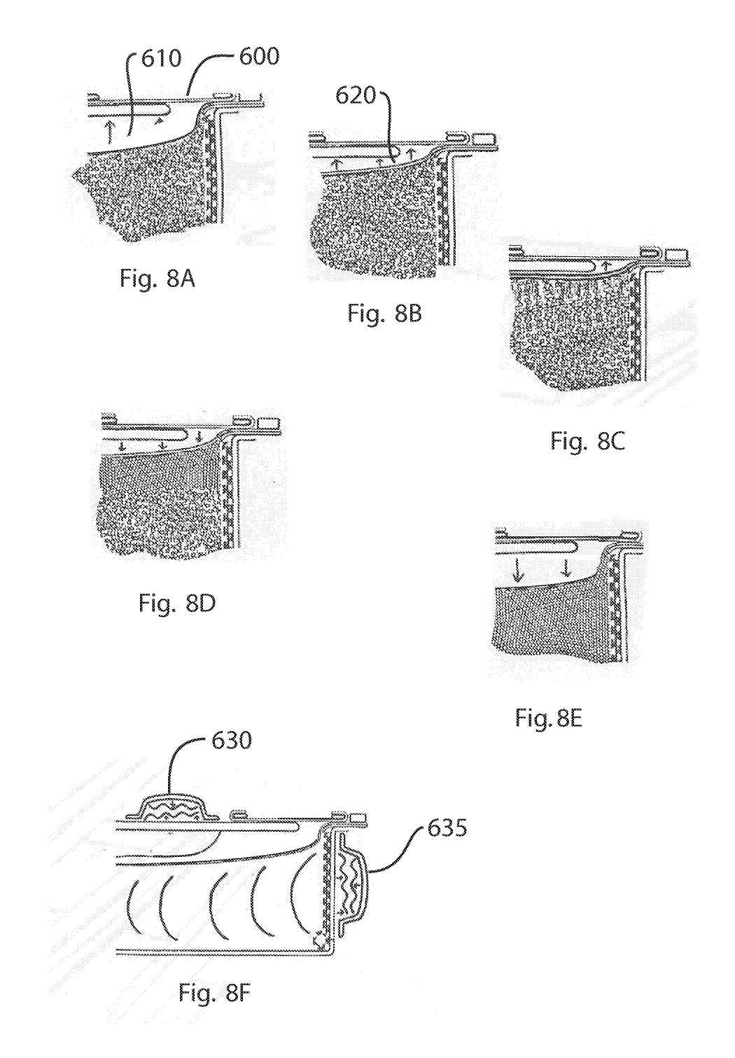

If the particles have not fully conformed to a master shape due to complexity of the master or other factors such insufficient agitation or freedom of the membrane to move over the pattern, then another operation step might be introduced. The container is partially softened by reintroduction of liquid, but not sufficiently to substantially lose the imparted shape. A thin slippery bleeder material such as a nonwoven polyester felt is placed over the formed membrane, the master shape is placed over the bleeder; and the vacuum cap is sealed over the master and again cycled to agitate the liquid and particle mass (further described with reference to FIGS. 7 and 8). Liquid is extracted to consolidate the particles, following which the vacuum cap is removed, the master shape and bleeder removed and the master replaced against the shaped surface of the container. The vacuum cap is again placed over the master, air extracted from beneath the vacuum cap and sufficient liquid reintroduced into the particle mass to allow slight formability. The surface membrane now has very little movement necessary to conform within its elastomeric limits to the master shape, following which the liquid is again extracted to immobilize and consolidate the particle mass against the membrane. Finally the vacuum cap and master part are removed from the formed surface of the membrane.

FIG. 7B shows the container set of FIGS. 4A and 4B with the modifications required to operate from the base station system shown in FIG. 7A. Active vacuum seal tube 110 is connected into seal ring 220 with a hand operated clip identical to clip 413. Evacuation tube 240 connects the seal ring to vacuum valve 525 of the system. Container liquid and evacuation lines 50 and 60 from the system are connected to both top and bottom containers.

Operation of the container and seal ring portion of the system is as follows. The containers are evacuated and infused with liquid as previously described. The seal ring with a mounted master shape is placed on the top surface of one container and the second container is placed on top of the seal ring. Seals 225 are activated by opening the clip on line 110. Valve 525 is then opened to evacuate air from between the container surface membranes via tube 240. Valve 530 may be alternately opened and closed in sequence with valve 525 to distribute the particulate matter as previously described. Valve 525 is then left open to hold vacuum between the container membranes while the excess liquid is extracted as previously described via valve 470. The valve remains open while valve 525 is closed and valve 530 opened to introduce atmosphere between the membranes. Finally the clip on line 110 is closed and vacuum bled off from seal ring seals 225 either by slipping a fine blade between the seals and container membrane frames or by separating tube 110 from the seal ring. The upper container is then lifted and the master shape is separated from the seal ring and removed from the bottom container.

Two halves of a mold cavity are now available. A castable foaming resin might be placed in the bottom container, following which the upper container is placed back on the seal ring and seals 225 again activated to hold the mold closed while the material cures. Alternatively the seal ring might have an injection or access port (previously described) through which a curing resin is introduced while the mold is closed.

FIG. 7C is a block diagram illustrating a process controller for the base station and toolbed of FIGS. 7A and 7B. The various valves and sensors are shown as blocks that include an alphabetic prefix before the reference number The controller takes sensor input from tank pressure transmitter 407 and container pressure transmitter 450. Tank pressure transmitter 407 enables the controller to maintain either a vacuum set point or a set pressure above atmospheric. As described above and shown immediately below in Table 1, the controller cycles the vacuum pumps and the base station valves (further identified in Table 1 below) to run the sequence of operations required to deaerate particles in the attached container, to infuse the particles with liquid and then to extract the liquid.

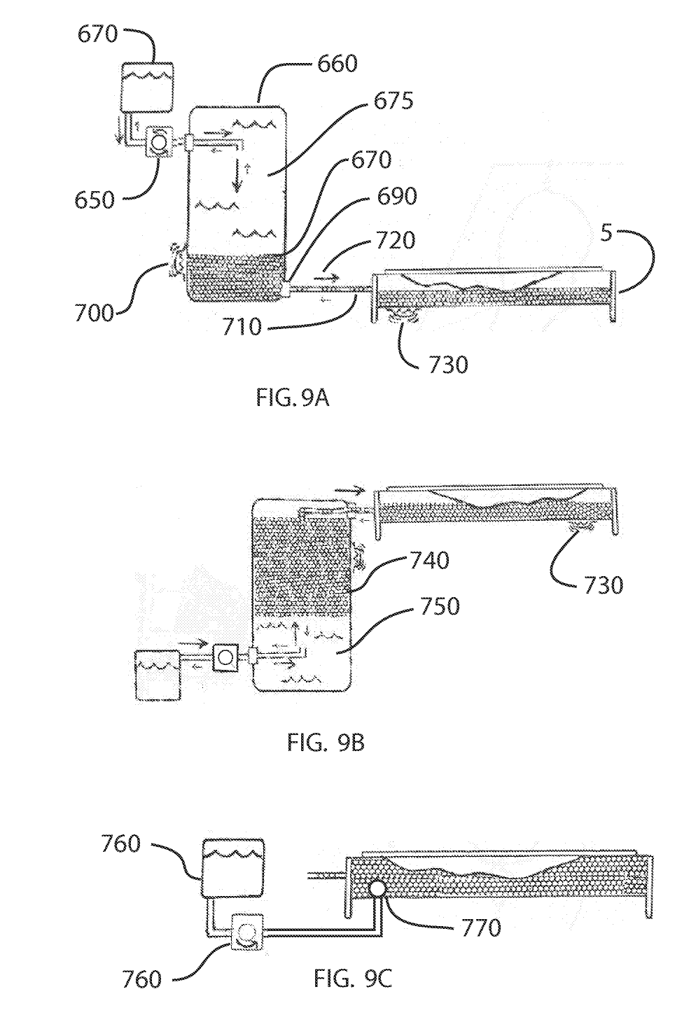

In addition the controller may operate elements such as radiant heater 550 with input from sensor 555 or perform a system shutdown and trigger an operator alarm if sensor 480 indicates a low liquid level. Regarding heat control, the controller could, for instance, also monitor the temperature of a heat exchanger 475 (sensor not shown) and turn a cooling fan on and off depending on heat exchanger temperature. Other sensing and control functions can be implemented such as control of agitation “pulsing”, liquid-transmitted vibration, surging or slurry flow control as will be discussed with reference to FIGS. 8A-9C.

The controller may operate any of a variety of process heaters and accept data input from radiant heat or direct contact sensors, including those within a heater air-stream or within the container to be formed. There may be exterior heaters for the containers, with exterior heat sources that may include radiant, convective air, microwave, radio-frequency, inductive or other heater types. There may also be interior heating sources such as resistance heaters or the transfer of heated fluid through the porous mass of the particles within the containers. Heat transfer within the particle mass is further aided if the particles are thermally conductive or can be resistively heated with electrical current. It will be understood that the process can be controlled by a controller that is capable of communication with operators or consumers over a network. The controller may also record and transmit process and use data to a remote location.

The controller, shown generically as including toolbed pressure control and tank pressure control modules, will typically be a computer-based system including a processor and memory. However, special-purpose process controllers, including hardwired and programmable types, may be used. Although not generally preferred, simple embodiments could in principle be controlled manually.

Table 1 shows the operating sequence of the base station for the containers shown in FIGS. 7A and 7B. Immediately below Table 1 are legends for the abbreviations used in the column (operation) and row (component) headings of Table 1. An “X” in a table cell denotes that the given valve is open during the given operation.

TABLE 1

| | DA | DA | Rel | Press | Rel | DA | Intro | Vac | Extr | Vent |
|---|---|---|---|---|---|---|---|---|---|---|
| | T400 | C5 | 400V | T400 | 400P | T400 | Liq | C90 | Liq | C90 |
| T400 | X | X | | X | | X | X | X | X | X |
| V430 | | | | | | | | | | |
| T400 | | | X | | X | | | | | |
| V432 | | | | | | | | | | |
| P415 | X | X | | | | X | | X | X | X |
| V440 | | | | | | | | | | |
| P420 | X | X | | | | X | | | | |
| V435 | | | | | | | | | | |
| 3-Way | X | X | | | X | X | X | X | X | X |
| V425 | | | | | | | | | | |
| A-B | | | | | | | | | | |
| 3-Way | | | X | | | | | | | |
| V425 | | | | | | | | | | |
| A-C | | | | | | | | | | |
| CE | | X | | | | | | | | |
| V445 | | | | | | | | | | |
| T400 | | X | | | | | X | | X | X |
| V470 | | | | | | | | | | |
| V-C | | | | | | | | X | X | |
| V525 | | | | | | | | | | |
| CV | | | | | | | | | | X |
| V520 | | | | | | | | | | |

| Abbreviations Used in | | Abbreviations Used in | |
|---|---|---|---|
| Column Headings of Table 1 | | Row Headings for Table 1 | |
| Abbreviated | Full Description | Abbreviated | Full Description |
| Operation | of Operation | Component | of Component |
| DA T400 | Deaerate | T400 V430 | Tank 400 vacuum/air |
| | tank 400 | | valve 430 |
| DA C5 | Deaerate | T400 V432 | Tank 400 vent |
| | container 5 | | valve 432 |
| Rel 400V | Relieve tank | P415 V440 | Pump 415 inlet |
| | 400 vacuum | | valve 440 |
| Press T400 | Pressurize | P420 V435 | Pump 420 inlet |
| | tank 400 | | valve 435 |
| Rel 400P | Relieve tank | 3-Way V425 | 3-way valve in |
| | 400 pressure | A-B | configuration A-B |
| DA T400 | Deaerate | 3-Way V425 | 3-way valve in |
| | TANK 400 | A-C | configuration A-C |
| Intro Liq | Introduce liquid | CE V445 | Container evacuation |
| Vac C90 | Vacuum to cap 90 | | valve 445 |
| Extr Liq | Extract liquid | T400 V470 | Tank 400 liquid |
| Vent C90 | Vent cap 90 | | valve 470 |
| | | V-C V525 | Vacuum-to-cap valve |
| | | | 525 |
| | | CV V520 | Cap vent valve 520 |

FIG. 7D shows the containers of FIGS. 4A and 4B closed around container 245, which is then formed within a cavity as described with reference to FIG. 6A. Seal ring 223 is employed, however with a vacuum-activated seal on both surfaces, and container 245 is fixed to it as previously described. Evacuation and seal tubes 240 and 110 are connected in the same manner as with seal ring 220 in the previous figure. However tube 265, which introduces pressurized air into container 245, and tube 270, which evacuates air from and introduces liquid to container 245, are also connected into the base station operating system. Tube 265 is connected to an air valve 555 which communicates with a pressurized air regulator 550. There is also a vent valve 560 connected to the tube. Tube 270 is connected to valve 560 which in turn communicates with tube 50 between valve 470 and liquid tank 400.

Operation to form container 245 is as follows after the seal ring with mounted container 245 has been sealed to the opposed formed containers. Valve 470 is closed to isolate the containers from liquid pressure during the operation. Valve 560 is initially opened while vacuum is on tank 400. This deaerates the particle volume within container 245, following which the tank is pressurized. Sufficient liquid to make the particle mass formable is then introduced to the container through valve 560. The valve is then closed and valve 525 is opened to evacuate air via the seal ring from the cavity within the opposed outside containers. At the same time air pressure is introduced via valve 555 through tube 265 to the interior of container 245. The container is driven by internal pressure against the walls of the cavity, and by alternately venting tube 265 via vent valve 560 while also cycling vacuum on line 240 as previously described, the volume of particles is once again “pulsed” and uniformly distributed within container 245.

To compress the particles against the cavity, valve 555 remains open to furnish interior pressure to the container while valve 525 is kept open to keep air evacuated from between container 245 and the cavity. Tank 400 then has the air space 405 evacuated, valve 560 is opened and liquid is extracted from the particle mass within container 245. Valves 525 and 555 are then closed and vent valves 530 and 560 are opened, and the particles remain compressed against the cavity by atmospheric pressure within the interior of container 245. With valve 560 remaining open to keep tank 400 vacuum on the particle volume, the outer containers can now be removed. With atmospheric pressure acting both on the interior and exterior of container 245, the particle mass remains compressed and so the container retains a shape complementary to the cavity within the outer containers.

Table 2 shows the sequence for the additional operations of FIG. 7D. These operations accomplish the forming of container 245 within the cavity formed by the outside containers. The operations could also be performed within any sealed cavity such as that formed by thin shell mold 275 or within any other stable mold cavity. For brevity, operation of tank 400 and vacuum pumps 415 and 420 are not included in the chart. However they cycle as shown in Table 1 above to provide air evacuation, liquid infusion and liquid extraction for container 245. Immediately below Table 2 are legends for the abbreviations used in the column (operation) and row (component) headings of Table 2. An “X” in a table cell denotes that the given valve is open during the given operation.

TABLE 2

| | DA | Intro | Evac | Press | Ext | Vent | Vent |
|---|---|---|---|---|---|---|---|
| | C245 | Liquid | Cav | CI | Liq | Con | Cav |
| C E/L | X | X | | | X | X | X |
| V560 | | | | | | | |
| CVac | | | X | X | X | X | |
| V525 | | | | | | | |
| CVac | | | | | | | X |
| V530 | | | | | | | |
| CVent | | | | X | X | | |
| V530 | | | | | | | |
| IntVent | | | | | | X | X |
| V560 | | | | | | | |

| Abbreviations Used in | | Abbreviations Used in | |
|---|---|---|---|
| Column Headings for Table 2 | | Row Headings for Table 2 | |
| Abbreviated | Full Description | Abbreviated | Full Description |
| Operation | of Operation | Component | of Component |
| DA C245 | Deaerate | C E/L V560 | Container evacuation/ |
| | container 245 | | liquid valve 560 |
| Intro Liq | Introduce liquid | CVac V525 | Cavity vacuum valve |
| | into container | | 525 |
| Evac Cav | Evacuate formed | CVac V530 | Cavity vacuum valve |
| | cavity | | 530 |
| Press CI | Pressurize | CVent V530 | Cavity vent valve 530 |
| | container interior | IntVent | Interior vent valve |
| Ext Liq | Extract liquid | V560 | 560 |
| Vent Con | Vent container | | |
| | interior | | |
| Vent Cav | Vent cavity to | | |
| | ambient | | |

Particle Agitation (FIGS. 8A-8F)

FIGS. 8A-8F show two methods for agitating a liquid-particulate mixture. Agitation provides surges of liquid relative to clusters of particles and provides local or broadly distributed surges depending on the method of agitation. The surges exert differential liquid forces on particles that displace them relative to one another and facilitate their movement into close-packed volumes. This may be especially important if the particles are irregular in size or geometry.

Particles may be selected for size or a mix of sizes, uniformity or a mix of geometries, and may be of uniform densities or a mix of densities. If the particles are of uniform density which matches the carrier liquid density, if they have no tendency to stick together while immersed in liquid and if they have uniform smooth geometry (e.g., spherical), then agitation and displacing surge forces may not be required. If the particles vary in only one parameter such as a significant size variation, then without agitation they may pack with significant voids between them. Agitation will facilitate chaotic movement of the particles relative to one other, and if carried on during extraction of transition liquid, the void structures will tend to be “filled in” and so present a more stable force-resisting structure when consolidated.

Two methods of agitation are shown. One of these acts locally, in the vicinity of an elastomeric membrane and a master part, while another method provides agitation throughout a volume of liquid. The first method, shown in FIGS. 8A-8E with particles that are less dense than the carrier liquid, employs a periodic variation in pressure between an elastic surface membrane 610 and an elastic membrane on vacuum cap 600. FIG. 8A shows initial dispersed particle conditions. A reduction in pressure causes atmospheric pressure, acting within the carrier liquid, to drive the liquid against the surface membrane and move it in regions where it does not abut against the master part, shown at region 620 in FIG. 8B.

The liquid tends to move between particles more rapidly than the particles move, creating the additional clearance as shown in FIG. 8C. FIG. 8D shows the disturbed particles settling into a closer-packed condition as the surface membrane is driven down due to atmospheric pressure again being introduced between the membranes, with the closer-packed condition progressing through the particle mass in FIG. 8E as the surface membrane further descends. If the reduction in pressure between membranes was then introduced slowly, the relatively close-packed particle mass would tend to rise and follow the surface membrane, and the well-ordered particles would tend to follow the membrane into intimate contact with the contained master part, as all air was evacuated between the surface membrane and the master.

FIG. 8F shows another method of agitation that employs low frequency vibrators 630 and 635 to create broadly or globally distributed liquid surges. Vibrator 635 is located on the container exterior and is pulsed while the first agitation procedure is used, and continues up to the time that full consolidation is achieved. Vibrator 630, located on the master part, is turned on after the surface membrane has been brought fully into contact with the master, and is left on until consolidation is finished.

Tests have shown that vibrations in the range of 3-10 Hertz, with an amplitude range of 1-5 mm, seem effective in agitating a particulate-liquid mixture with the following characteristics. The total mixture volume is in the range of 36 liters. The particles are proximally irregular microspheres with a size range of 100-250 microns, with an approximate 50% distribution at 150 microns. The particle density is 0.6-0.8 g/cc, while the liquid density is around 1.3 g/cc. It is contemplated that the vibration procedures will be useful with nearly any particle and carrier liquid mixture.

Slurry Flow (FIGS. 9A-9C)

FIGS. 9A and 9B show a form of agitation that helps to carry a state-change mixture from a tank to a containing volume and back again. Pulsations of liquid flow are employed to allow a mixture of substantially close-packed particles to move through fittings, valves, pipes and tubing without blockage occurring. The pulsations have two components which act together to loosen and move particles of the mixture progressively in one direction. One component of the pulsation is a periodical surge induced by a pump, while the other component is induced by vibrations that are transmitted through the liquid.

FIG. 9A shows a mixture tank 660 containing a state-change mixture with particles 670 that are denser than the carrier liquid 675. A liquid tank 670 furnishes liquid to keep mixture tank 660 filled with liquid as a volume of mixture is transferred from mixture tank to a container 5.

Pump 650 intermittently injects a quantity of liquid into tank 660, causing a surge of the mixture to travel from the mixture tank towards container 5. The pump then extracts a smaller quantity of liquid from tank 660, causing a smaller surge of the material to travel back towards the tank. This surge will cause jammed particles, such those at restriction 690, to be agitated and returned to the stream of fluid within pipe 710. This alternating larger forward surge and smaller backward surge prevents an accumulation of particles from building up and blocking the pipe, while at the same time assuring that the net flow of particles is into the container.

A liquid vibrator 700 is also employed to assure movement of the particles past restriction 690. The induced amplitude of the liquid vibrations agitates the particles through a distance that may be on the scale of the diameter of the particles, thus adding small-scale liquid surges to furnish additional dislodging forces on jammed particles. The frequency of the vibrations is adjusted to furnish sufficient displacement of one particle relative to another to keep the particles moving freely in relation to one another.

To remove a quantity of mixture from container 5, pump 650 intermittently pulses the liquid as described above; however the greater surge is from the container towards tank 660. Another vibrator 730 acts on the container side as vibrator 700 acts on the tank side to furnish additional dislodging forces on the particles.

FIG. 9B shows a mixture with particles 740 that are less dense than a carrier liquid 750. The liquid is now pumped into the bottom of the container and the mixture transferred from the top of the mixture tank. In all other regards the transfer of mixture from the tank to a container and back again is accomplished with the previously described method.

FIG. 9C shows a method of close-packing the particles in a container. While transition liquid is extracted from the container, pump 765 pumps liquid from a tank 760 to a volume element, bladder 710, to occupy a volume equal to the extracted liquid, in effect substituting a volume equal to the volume removed. This assures that the container's volume remains constant and completely filled, and that the particles are forced against the master part.

### CONCLUSION

In conclusion, it can be seen that the present invention provides elegant techniques for forming a wide variety of objects and tooling.

It can be appreciated that there are numerous variations of containers and varied combinations of containers which can be employed either to form a surface which is complementary to the exterior surface of a master shape in part or in whole, or to form a surface or surfaces complementary to the interior contours of a hollow master shape or master cavity. For instance more than one container of the first type (rigid frame) or second type (flexible-edge) can be employed to form a continuous surface complementary to a master shape's surface, with the elastomeric membranes of the containers either overlapping or being abutted together. Containers of the second type may also have a membrane and particle configuration that allows two or more of the containers to be “tiled” together to form a continuous surface of particle-backed membranes. Likewise two or more containers of the third type can be employed together to form a shape complementary to the interior of a master cavity.

The above exemplary systems and methods have been described to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself. Thus, while the above is a complete description of specific embodiments of the invention, the above description should not be taken as limiting the scope of the invention as defined by the claims.

While the above is a complete description of specific embodiments of the invention, the above description should not be taken as limiting the scope of the invention as defined by the claims.

1. A method of forming an object in accordance with a master shape, the method comprising:
providing a container having first and second elastomeric membranes;
providing a volume of particles in the container;
introducing a sufficient amount of liquid into the volume of particles to cause a mixture of the particles and liquid to assume a formable state;
pressing the master shape into the first membrane with atmospheric pressure to cause the mixture to conform to the master shape; and
extracting a sufficient amount of liquid from the container to cause the mixture to assume a stable, force-resisting state, thereby forming the object.

2. The method of claim 1 wherein:
the volume of particles is provided in the container in a substantially dry form;
the liquid is introduced into the volume of particles after the volume of particles is in the container; and
the amount of liquid introduced into the volume of particles is sufficient to substantially fill interstices between the individual particles, and further includes an excess amount of liquid.

3. The method of claim 1 wherein:
the liquid is introduced into the volume of particles to form the mixture in the formable state before the volume of particles is in the container; and
providing the volume of particles in the container is accomplished by introducing the mixture in the formable state into the container.

4. The method of claim 1 wherein:
the volume of particles is provided in the container as a mixture with a first amount of liquid that partially fills interstices between individual particles, but is insufficient for the mixture to be in the formable state;
introducing the sufficient amount of liquid into the volume of particles is accomplished by introducing a second amount of liquid into the container after the volume of particles and the first amount of liquid are already in the container; and
the first and second amounts of liquid, when combined with the volume of particles, result in the mixture in the formable state.

5. The method of claim 1 wherein:
the volume of particles is provided in the container before the sufficient amount of liquid is introduced; and
the method further comprises deaerating the volume of particles before introducing the sufficient amount of liquid.

6. The method of claim 1 wherein extracting the sufficient amount of liquid comprises extracting the liquid through one or more screen elements placed proximal to the volume of particles.

7. The method of claim 1, and further comprising heating and driving liquid from the particle volume.

8. The method of claim 1, and further comprising providing a binding adhesive to lock the particles into a force-resisting mass.

9. The method of claim 1, comprising pressing a shape complementary to the master shape in the membrane.

10. The method of claim 1 wherein pressing the master shape into the first membrane comprises:
applying a flexible vacuum cap sealed over the shape and against the first membrane; and
evacuating air from a space between the first membrane and the vacuum cap so that the particles and the master shape are pressed together by atmospheric pressure acting in opposed directions against the vacuum cap and the second membrane.

11. The method of claim 10, and further comprising:
introducing air into the vacuum cap; and
removing the cap and the master shape from the formed surface of the first membrane.

12. The method of claim 1 wherein pressing the master shape into the first membrane comprises:
placing the master shape on an air-impermeable surface;
placing a membrane of the container over the shape; and
placing a vacuum cap or a vacuum-bagging film over the container to effect forming of the elastomeric membrane against the master shape.

13. The method of claim 1, comprising applying an envelope containing a mass of particles and with a vacuum seal on a perimeter to extract air from between the master shape and the envelope.

14. The method of claim 1, comprising placing the master shape on the top elastomeric surface of a first rigid-framed container and placing a membrane surface of a second container over the master shape.

15. The method of claim 14 wherein the second container fits inside the frame of the first container and a vacuum cap is positioned and sealed outside the second container against the surface membrane of the first container.

16-29. (canceled)

30. The method of claim 1, comprising:
providing a release surface to the master shape;
pressing the master shape against the volume of particles to form the object with the release surface; and
removing the object using the release surface.

31. The method of claim 30 wherein providing the release surface comprises providing an area around the master shape with a surface element covering the reformable material surface not overlaid with the master shape surface.

32. A method of forming an object in accordance with a master shape, the method comprising:
providing a container having an elastomeric membrane;
providing a volume of particles in the container, the volume of particles having at least some air in interstices between individual particles;
deaerating container to remove air from the interstices;
introducing a sufficient amount of liquid into the volume of particles to cause a mixture of the particles and liquid to assume a formable state;
pressing the master shape into the membrane with atmospheric pressure to cause the mixture to conform to the master shape; and
extracting a sufficient amount of liquid from the container to cause the mixture to assume a stable, force-resisting state.

33. Apparatus for forming an object in accordance with a master shape, comprising:
a container to hold a volume of particles, said container including
a frame with first and second elastomeric membranes,
a first port to deaerate the volume of particles, and
a second port for introducing a sufficient amount of liquid into the volume of particles to cause a mixture of the particles and liquid to assume a formable state; and
a press coupled to the container to move the master shape into the first membrane to cause the mixture to conform to the master shape, thereby forming the object.

34. The apparatus of claim 33 wherein the second membrane is bonded to the frame.

35. The apparatus of claim 33 wherein the first membrane is coupled to a seal.

36. The apparatus of claim 33, comprising a clamp to secure at least one membrane to the frame.

37. The apparatus of claim 33, comprising one or more ports on the frame.

38. The apparatus of claim 33, comprising liquid, evacuation, and vacuum-activated seal tubes coupled to the frame.

39. The apparatus of claim 33, comprising a rim evacuation screen element positioned in the frame.

40. The apparatus of claim 33, comprising a vacuum activated seal on the frame.

41. The apparatus of claim 33, comprising a tube to evacuate and fill the container.

42-73. (canceled)

74. Apparatus for forming an object in accordance with a master shape, comprising:
a container to hold a volume of particles, said container including
an elastomeric membrane,
a first port to deaerate the volume of particles, and
a second port for introducing a sufficient amount of liquid into the volume of particles to cause a mixture of the particles and liquid to assume a formable state;
a vacuum activated seal for the container, said seal including
a channel having one or more legs angled outwardly and spaced apart, said legs having contact areas adapted to be pressed against a surface with a greater force per unit area than atmospheric pressure, said channel having an opening therein, and
a tube penetrating from the outside of the channel to the inside of the channel through the opening; and
a press coupled to the container to move the master shape into the membrane to shape a reformable material into the object according to the master shape.

75. A base station for forming an object in accordance with a master shape, comprising:
a liquid receiver;
a vacuum source to evacuate air from the liquid receiver;
an air compressor to generate pressurized air; and
a controller coupled to the liquid receiver, the vacuum source, and the air compressor to form the object.

76. The base station of claim 75, comprising one or more tubes to provide vacuum and to control the flow of liquids to and from the receiver.

77. The base station of claim 75, and further comprising one or more valves coupled to the controller.

78. The base station of claim 75, and further comprising one or more sensors coupled to the controller.

79. The base station of claim 75, and further comprising an electrical power supply to operate valves, sensors, the vacuum pump and the air compressor.

80-109. (canceled)

110. A method for shaping a reformable material, comprising:
holding a volume of particles inside a container having a first elastomeric membrane surface;
infusing the volume of particles with a liquid;
agitating the liquid to provide one or more surges of liquid to mobilize the volume of particles; and
pressing a master shape into the membrane with atmospheric pressure.

111-126. (canceled)

127. The method of claim 110, where the one or more surges include a first surge of liquid towards a desired transport direction.

128. The method of claim 127, wherein the one or more surges include a second surge smaller than the first surge in an opposite direction to the transport direction.

129-131. (canceled)

132. A vacuum activated seal for a container, comprising:
a channel having one or more legs angled outwardly and spaced apart, said legs having contact areas adapted to be pressed against a surface with a greater force per unit area than atmospheric pressure;
said channel having an opening therein; and
a tube penetrating from the outside of the channel to the inside of the channel through the opening.

133-149. (canceled)
